(19) United States
(12) Patent Application Publication
(10) Pub. No.: US 2025/0310750 A1
(43) Pub. Date: Oct. 2, 2025

(54) SYSTEMS AND METHODS FOR DERIVING ACCESS AND MOBILITY POLICY IN VISITED NETWORKS

(71) Applicant: Verizon Patent and Licensing Inc., Basking Ridge, NJ (US)

(72) Inventors: Lixia Yan, Basking Ridge, NJ (US); Violeta Cakulev, Millburn, NJ (US); Ali Imdad Malik, East Brunswick, NJ (US); Hossein M. Ahmadi, Parsippany, NJ (US)

(21) Appl. No.: 18/618,487

(22) Filed: Mar. 27, 2024

(51) Int. Cl. H04W 8/10

(52) U.S. Cl. CPC H04W 8/10

(57) ABSTRACT

A method, a device, and a non-transitory storage medium provide an enhanced access and mobility policy service. A network device in a visited network receives a roaming request to connect to the visited network for a user equipment (UE) device. The network device determines, based on a first access and mobility (AM) policy association request, whether a home network for the UE device has a subscriber-specific roaming policy. When the home network for the UE device has a subscriber-specific roaming policy the network device sends a second AM policy association request to the home network; receives, from the home network, the AM policy for the roaming UE device; and sends an AM policy association response to the first AM policy association request.

### BACKGROUND INFORMATION

Public Land Mobile Networks (PLMNs) are traditionally designed to support mobile devices over an extensive geographic area (e.g., national or regional coverage). When a subscriber with one PLMN operator (e.g., a “home” PLMN) is unable to connect for service, another PLMN operator (e.g., a “visited” PLMN) may provide roaming services, based on an agreement between the PLMN operators. A PLMN identifier (ID) includes a Mobile Country Code (MCC) and a Mobile Network Code (MNC) that uniquely identifies a network and its home network subscribers.

### BRIEF DESCRIPTION OF THE DRAWINGS

FIG. 1 provides an example of an environment in which an access and mobility (AM) policy service for roaming may be implemented;

FIG. 2 is a diagram illustrating components of a home networks and visited network for the AM policy service, according to an implementation;

FIG. 3 is a table illustrating example associations of a PLMN ID to a roaming mode for the AM Policy service;

FIGS. 4A and 4B are diagrams illustrating exemplary communications for the AM policy service, according to an implementation;

FIG. 5 is a flow chart of example operations for the AM policy service, according to an implementation;

FIG. 6 is a diagram illustrating exemplary components of a device that may correspond to one or more of the devices illustrated herein;

FIGS. 7 and 8 illustrate different use cases for the AM policy service.

### DETAILED DESCRIPTION

The following detailed description refers to the accompanying drawings. The same reference numbers in different drawings may identify the same or similar elements. Also, the following detailed description does not limit the invention.

An enhanced core network deployment technique for use in a Fifth Generation (5G) Standalone (SA) architecture may enable separation of access and mobility policy enforcement from other policy functions. For example, a policy control function (PCF) may be split into a session management (SM)-PCF, a user equipment (UE)-PCF, and an access and mobility (AM)-PCF that may operate independently. The SM-PCF may manage session management policies and provide session management control services, among other functions. The UE-PCF may manage UE policy information and provide UE policy control services, among other functions. The AM-PCF may interact with an access and mobility management function (AMF) and may provide policies that relate to access and mobility management to the AMF.

When a UE device, such as smartphone, is roaming (e.g., requiring service outside a coverage area of a home PLMN or home network), the UE device may request service from a visited network (e.g., another PLMN). An AMF in the visited network will query a visited AM-PCF (or V-AM-PCF) to obtain AM policy guidance for the UE device. The V-AM-PCF may then locally derive the AM policy for the UE device based on a roaming agreement between service providers of the visited PLMN and a home PLMN. Typically, this roaming agreement applies to all subscribers that belong to a PLMN. For example, the visited PLMN may allow the subscribers of a third party network to utilize the visited PLMN based on a policy that is established per PLMN identifier (ID).

National and international roaming requires a PLMN operator (e.g., of a visited PLMN) to sign a roaming agreement with a third-party network (e.g., the home PLMN) prior to the roaming. The roaming agreement typically assumes that all the third-party network subscribers will receive similar treatment and services during roaming based on their unique PLMN ID. That is, since the V-AM-PCF derives the AM policy based on a roaming agreement associated with the PLMN ID, the visited network is not able to provide AM policy control at a per subscriber level.

Systems and methods described herein provide an AM policy service for roaming that supports AM policy control at a per subscriber level. The systems and methods may trigger communications between a visited network and a subscriber's home network to retrieve a subscriber-specific AM policy from a home AM-PCF when needed. According to an implementation, a network device (e.g., an AM-PCF) in a visited network may receive (e.g., from an AMF in the visited network) an AM policy association request for a roaming UE device. The network device may determine, based on the AM policy association request, whether a home network for the UE device has subscriber-specific roaming policies. When the home network for the UE device has subscriber-specific roaming policies, the network device may forward the AM policy association request to the home network. The network device may then receive, from the home network, the AM policy for the roaming UE device and send an AM policy association response, with subscriber-specific policies, for the AM policy association request.

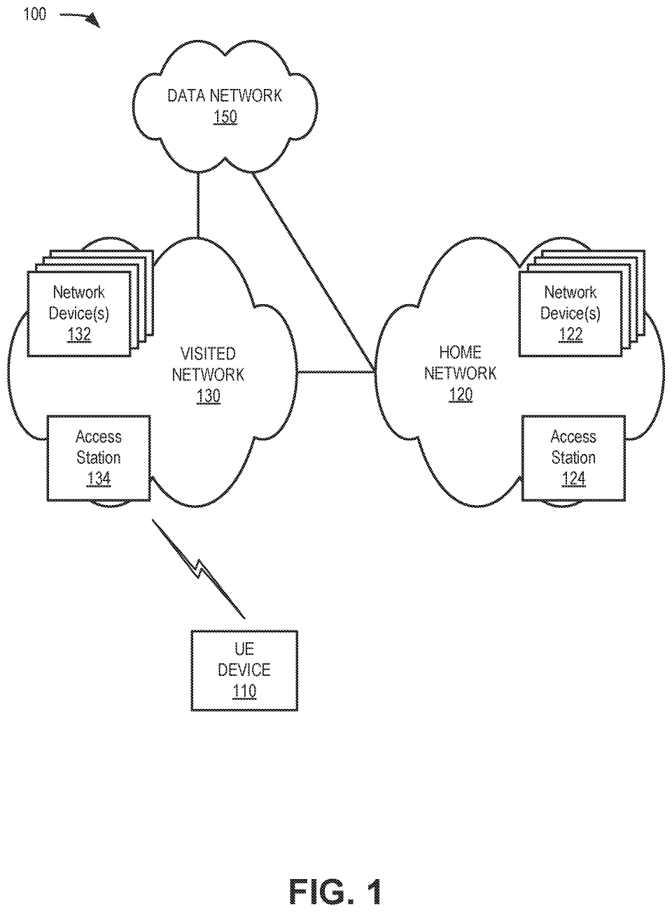

FIG. 1 provides an overview of a network environment 100 in which an AM policy service may be implemented. As shown, network environment 100 may include a UE device 110, a home network 120, a visited network 130, and a data network 150.

UE device 110 may include a wireless communication device. Examples of UE device 110 include a cellular telephone device (e.g., a conventional cell phone with data processing capabilities), a smart phone, a personal digital assistant (PDA) that can include a radiotelephone, a wearable computer (e.g., a smart watch), a vehicle telematics system, an Internet-of-Things (IoT) device, etc. UE device 110 may store, for example, a home network ID (e.g., a PLMN ID) or other indicator that identifies the home network of a subscriber.

Home network 120 may include a network of a wireless carrier that is associated with UE device 110 via a subscription. Home network 120 may be a default/primary network for providing service to UE device 110. Home network 120 may include, for example, a radio access network (RAN), a core network, and other networks. For example, home network 120 may include a local area network (LAN), a wireless LAN, a wide area network (WAN), a metropolitan area network (MAN), an optical network, a cable television network, a satellite network, a wireless network (e.g., a Code Division Multiple Access (CDMA) network, a general packet radio service (GPRS) network, a Long Term Evolution (LTE) network (e.g., 4G network), a 5G network, a 6G or future network, an ad hoc network, a telephone network (e.g., the Public Switched Telephone Network (PSTN) or a cellular network), an intranet, or a combination of networks. Home network 120 may allow the delivery of Internet Protocol (IP) services to UE device 110 and may interface with and/or include other networks, such as a packet data network (PDN).

Depending on the implementation, home network 120 may include one or multiple types of network devices 122. For example, network devices 122 may include RAN devices, such as a next generation Node B (gNB), an enhanced LTE (eLTE) evolved Node B (eNB), an eNB, a radio network controller (RNC), a radio intelligent controller (RIC), a base station controller (BSC), a remote radio head (RRH), a baseband unit (BBU), a radio unit (RU), a remote radio unit (RRU), a centralized unit (CU), a distributed unit (DU), a small cell node (e.g., a picocell device, a femtocell device, a microcell device, a home eNB, a home gNB, etc.), a 5G ultra-wide band (UWB) node, a future generation wireless access device (e.g., a 6G wireless station, a 7G wireless station, or another generation of wireless station). In the illustration of FIG. 1, an access station 124, which may include one of network devices 122, may establish a wireless connection with UE device 110 to home network 120.

In other implementations, network devices 122 may include core network devices, such as a user plane function (UPF), a network data analytics function (NWDAF), an access and mobility management function (AMF), a session management function (SMF), a unified data management (UDM) device, a unified data repository (UDR), an application function (AF), an authentication server function (AUSF), a security anchor function (SEAF), a network slice selection function (NSSF), a network repository function (NRF), a policy control function (PCF), a network exposure function (NEF), a service capability exposure function (SCEF), a mobility management entity (MME), a packet data network gateway (PGW), a serving gateway (SGW), a home subscriber server (HSS), an authentication, authorization, and accounting (AAA) server, a policy and charging rules function (PCRF), and/or a charging system (CS). According to other implementations, network devices 122 may include additional, different, and/or fewer network devices than those described. For example, network device 122 may include a gateway, a router, a switch, a firewall, a bridge, a proxy server, a server, or some other type of device that processes and/or transfers data.

Visited network 130 may include a network of a wireless carrier that is not a home network for UE device 110 (e.g., a network that is not registered as a primary network for UE device 110). For example, visited network 130 may be associated with a wireless carrier that supports a roaming agreement for UE device 110 or that otherwise may be able to support network services and/or application services when home network 120 is not available to UE device 110. Visited network 130 may generally include features similar to those of home network 120 and have network devices 132 similar to those described above for home network 120 and network devices 122. However, as a visited network, some services and other system capabilities of a home network are not typically available to a visiting UE device 110. In the illustration of FIG. 1, an access station 134, which may include one of network devices 132, may establish a wireless connection with a UE device 110 to visited network 130, when UE device 110 cannot access home network 120.

Data network 150 may include, for example, a packet data network. In an implementation, UE device 110 may connect to data network 150 via visited network 130. Data network 150 may also include and/or be connected to a local area network (LAN), a wide area network (WAN), a metropolitan area network (MAN), an autonomous system (AS) on the Internet, an optical network, a cable television network, a satellite network, a wireless network, an ad hoc network, a telephone network (e.g., the Public Switched Telephone Network (PSTN) or a cellular network), an intranet, or a combination of networks.

The number of devices, the number of networks, and the configuration in environment 100 are exemplary. According to other embodiments, environment 100 may include additional devices, fewer devices, and/or differently arranged devices, than those illustrated in FIG. 1. For example, according to other embodiments, environment 100 may include additional wired and/or wireless networks.

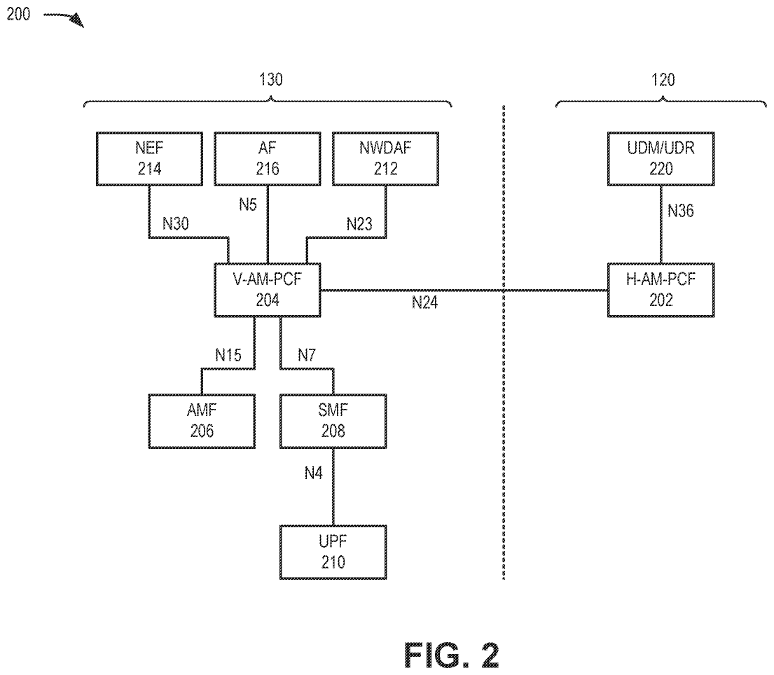

FIG. 2 is a diagram of a portion 200 of network environment 100 including components of networks 120 and 130 for the AM policy service, according to an implementation. As shown in FIG. 2, home network 120 may include a home AM-PCF (H-AM-PCF) 202 and a UDM/UDR 220. Visited network 130 may include a visited AM-PCF (V-AM-PCF) 204, an AMF 206, an SMF 208, a UPF 210, a NWDAF 212, a NEF 214, and an AF 216.

Each of H-AM-PCF 202 and V-AM-PCF 204 may provide policies/rules to control plane network devices, and make policy decisions based on subscription information, among other functions. Among other interactions, H-AM-PCF 202 and V-AM-PCF 204 may communicate with each other via an N24 interface.

V-AM-PCF 204 may accept or reject a registration request, such as a registration request from a roaming UE device 110, based on a PLMN ID for the home network (e.g. home network 120) associated with the UE device 110. According to an implementation, V-AM-PCF 204 may store a record of PMLN IDs for which roaming is supported in network 120. Each PLMN ID may be associated with a general roaming policy or a subscriber-specific roaming policy. If the PLMN ID for UE device 110 is associated with a general roaming policy, V-AM-PCF 204 may retrieve a locally stored (e.g., within visited network 130) access and mobility policy consistent with a roaming agreement for the PLMN ID. If the PLMN ID for UE device 110 is associated with a subscriber-specific roaming policy, V-AM-PCF 204 may communicate with H-AM-PCF 202 to obtain a user-specific AM policy for UE 110, as described further herein. Visited AM-PCF 204 may provide the general AM policy or the subscriber-specific AM policy to AMF 206 for enforcement. For example, V-AM-PCF 204 may communicate with AMF 206 and may provide policies that relate to access and mobility management.

Home AM-PCF 202 may receive an AM Policy Association Request from V-AM-PCF 204 when UE device 110 attempts to register with visited network 130. In response to the request from V-AM-PCF 204, H-AM-PCF 202 may retrieve (e.g., from UDM/UDR 220) a subscriber profile associated with UE device 110. Using the subscriber profile, H-AM-PCF 202 may dynamically derive an AM Policy for UE device 110 based on, for example, a subscription type or price plan indicated in the subscriber profile.

UDM/UDR 220 may manage data for access authorization, user registration, and data network policies, among other functions. For example, UDR 220 may store user profiles and/or roaming policies for subscribers of home network 120. UDM 220 may provide profiles and/or roaming policies to H-AM-PCF 202, for example, during roaming access procedures. Among other interactions, UDM/UDR 220 may interact with H-AM-PCF 202 via an N36 interface. According to an implementation, UDM/UDR 220 may store subscriber-specific policies for roaming access (e.g., polices to permit roaming, policies to set service types when roaming, etc.).

AMF 206 may provide registration, connection, reachability, and mobility management, security context management, location service management, UE mobility event notification, among other functions. Among other interactions, AMF 206 may interact with V-AM-PCF 204 via an N15 interface.

Visited SMF 208 may provide session management, Internet Protocol (IP) address allocation and management, selection, and control of user plane (UP) function, configuration of traffic steering, control of policy enforcement and quality of service (QOS), among other functions. Among other interactions, SMF 208 may interact with V-AM-PCF 204 via an N7 interface.

Visited UPF 210 may maintain an anchor point for intra/inter-RAT mobility, maintain an external protocol data unit (PDU) point of interconnect to a particular data network (e.g., data network 150), perform packet routing and forwarding, perform the user plane part of policy rule enforcement, perform packet inspection, perform Quality of Service (QOS) handling in the user plane, perform uplink traffic verification, and/or perform other types of user plane processes. Among other interactions, UPF 210 may interact with SMF 208 over an N4 interface.

Visited NEF 214 may expose services, capabilities, and events provided by other network devices, securely provision information from external network devices, and translate internal and external information relative to network 130. Among other interactions, NEF 214 may interact with V-AM-PCF 204 via an N30 interface.

Visited AF 216 may support application influence on traffic routing, accessing NEF 214, and interacting with the policy framework for policy control. AF 216 may or may not be a third party network device (e.g., relative to UE device 110 and a provider of visited network 130). Among other interactions, AF 216 may interact with V-AM-PCF 204 via an N5 interface.

Visited NWDAF 212 may consume statistics, metrics, and events from 5G network functions, retrieve management statistics from an Operations, Administration, and Maintenance (OAM) device, provide network function discovery and identification, perform machine learning (ML) modeling, network optimization, cost efficiency, resource management, among other functions. Among other interactions, NWDAF 212 may interact with V-AM-PCF 204 via an N23 interface.

According to implementations described herein, the AM policy service may be facilitated through communications between H-AM-PCF 202 and V-AM-PCF 204. For example, V-AM-PCF 204 may trigger an AM Policy Association Request to H-AM-PCF 202 to retrieve an AM Policy from home network 120 when necessary. More particularly, V-AM-PCF 204 may trigger an AM Policy Association Request to H-AM-PCF 202 only when it is required based on the subscriber's home PLMN ID (e.g., as provided by UE device 110). In response to the AM Policy Association Request, H-AM-PCF 202 may provide an AM Policy Association Response that include an AM Policy for the particular UE device 110. According to one implementation, the AM Policy Association Request and the AM Policy Association Response may be exchanged via a modified N24 interface (e.g., relative to a current 3GPP standard) that is configured to support the AM policy service. According to another implementation, another interface or set of application programming interfaces (APIs) may be used to support the AM policy service.

FIG. 2 illustrates exemplary components of network portion 200 to support the AM policy service. According to other exemplary embodiments, additional components, fewer components, and/or different components than those illustrated and described may be used to provide the AM policy service.

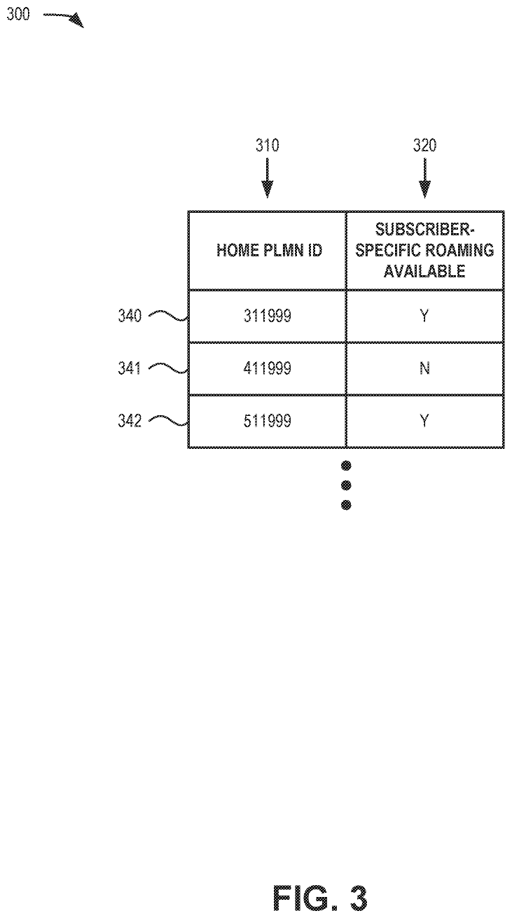

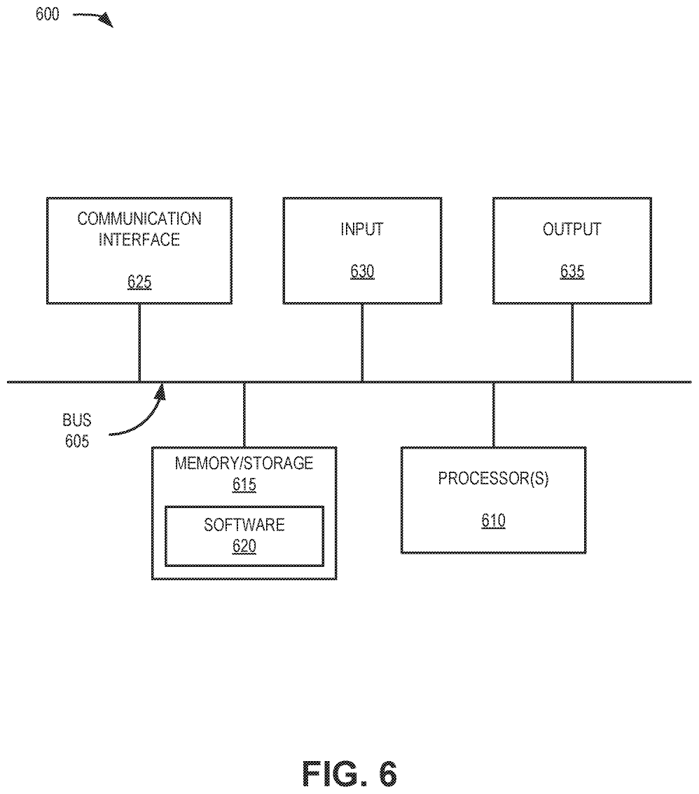

FIG. 3 is a table 300 illustrating example associations of a PLMN ID to a roaming mode of the AM Policy service. Table 300 may be stored, for example, in a memory (e.g., memory/storage 615, FIG. 6) of V-AM-PCF 204 or a memory accessible to V-AM-PCF 204. Table 300 may include a home PLMN ID field 310, a mode designation field 320, and a variety of entries 340-342. Table 300 is a simplified example of parameters that may be used by V-AM-PCF 204 with the AM policy service.

As shown in FIG. 3, home PLMN ID field 310 may include a PLMN ID associated with a third-party PLMN (e.g., home network 120). Mode designation field 320 may indicate a roaming mode that is contracted with the service provider for the PLMN ID in field 310. Mode designation field 320 may indicate, for example, whether the roaming policy for the home PLMN ID is general (e.g., the same policy for all UE devices having the corresponding PLMN ID) or subscriber-specific (e.g., requiring an AM Policy Association Request to the home AM-PCF 202).

In table 300, entry 340 associates a PLMN ID (i.e., “311999”) with a subscriber-specific roaming mode (i.e., “Y”) which would trigger V-AM-PCF 204 to obtain a network address for an AM-PCF the home PLMN ID. Entry 341 associates another PLMN ID (i.e., “411999”) with a general roaming mode (i.e., “N”) which would not require a network address for an AM-PCF. Entry 342 associates still another PLMN ID (i.e., “511999”) with a subscriber-specific roaming mode (i.e., “Y”). Using table 300, V-AM-PCF 204 may match a home PLMN ID received from a roaming UE device 110 to one of the entries 340-342 to determine whether the home network for the UE device has a subscriber-specific roaming policy. In one implementation, if a subscriber-specific roaming policy is associated with UE device 110, V-AM-PCF 204 may initiate a query to retrieve a network address for directing an AM Policy Association Request to H-AM-PCF 202. For example, V-AM-PCF 204 may query an NRF in visited network 130, which in turn may query a NRF in home network 120 to obtain the network address of H-AM-PCF 202.

Table 300 shows one arrangement of parameters to indicate whether a home network has a subscriber-specific roaming policy. In other implementations, table 300 may include different, additional, or fewer parameters than those illustrated. Furthermore, parameters of table 300 may be provided in a different format or data structure (e.g., a list, database, flat file, etc.) in other implementations.

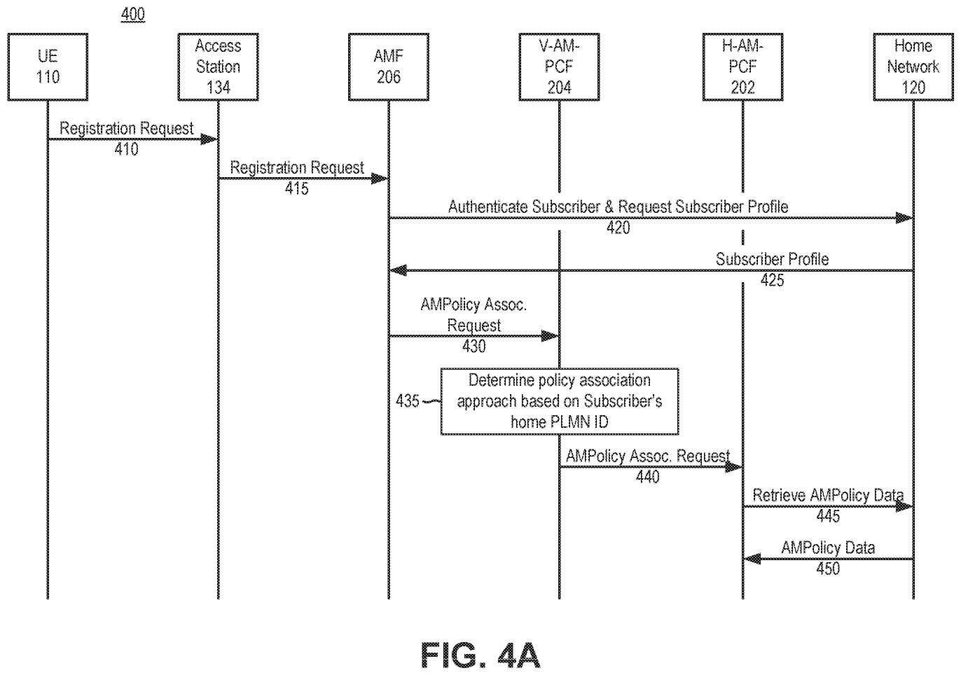

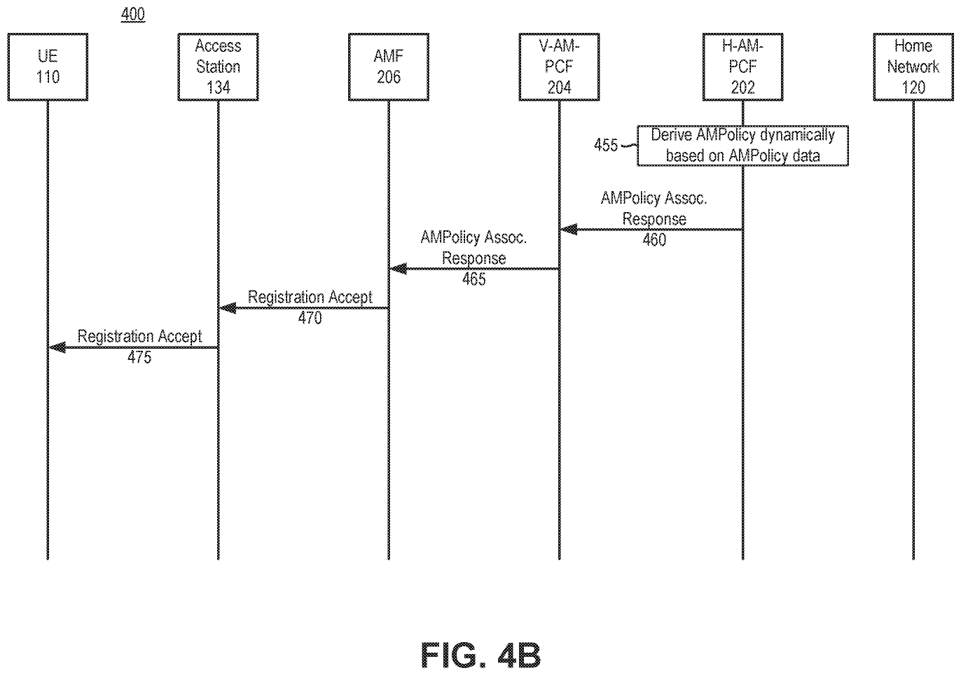

FIGS. 4A and 4B are diagrams illustrating exemplary communications for the AM policy service in a portion 400 network environment 100, according to an implementation. Network portion 400 may include UE device 110, access station 134, AMF 206, V-AM-PCF 204, H-AM-PCF 202, and home network 120. FIGS. 4A and 4B provide a simplified illustration of communications in network portion 400 and is not intended to reflect every signal, communication, or intermediate points for exchanges between functions/devices.

As shown in FIG. 4A, a UE device 110 may submit to access station 134 a registration request 410 to access visited network 130. Registration request 410 may include, for example, a unique device identifier (e.g., a subscription permanent identifier (SUPI), an international mobile subscriber identity (IMSI), or the like) and a PLMN ID of a home network (e.g., home network 120). Access station 134 may receive registration request 410 and forward the request to AMF 206 as registration request 415 (also referred to as a roaming request).

AMF 206 may receive registration request 415 and perform authentication associated with registering UE 110. For example, AMF 206 may determine if UE device 110 is authorized to establish a data session, such as whether UE device 110 is associated with a subscriber to a network that has a roaming agreement for visited network 130. AMF 206 may use the PLMN ID to identify the home network 120 for UE device 110. AMF 206 may send request 420 to obtain from home network 120 a subscriber profile for the user of UE device 110. Home network 120 (e.g., an AUSF, UDM, and/or UDR of home network 120) may retrieve the appropriate subscriber profile. For this example, assume that UE device 110 is authenticated and home network 120 returns subscriber profile 425 to the visited AMF 206.

After receiving the subscriber profile, AMF 206 may provide an AM policy association request 430 to V-AM-PCF 204. The AM policy association request 430 may request what rules to apply to UE device 110. In response to AM policy association request 430, V-AM-PCF 204 may determine 435 a policy association approach (e.g., whether or not to interact with H-AM-PCF 202) based on a subscriber's home PLMN ID. For example, V-AM-PCF 204 may determine a policy for UE device 110 (e.g., based on a general roaming profile for the PLMN ID), or V-AM-PCF 204 may initiate a request to H-AM-PCF 202 (e.g., if the PLMN ID is associated with subscriber-specific roaming policies).

Assuming V-AM-PCF 204 determines that the PLMN ID of AM policy association request 430 is configured for subscriber-specific roaming, V-AM-PCF 204 may provide AM policy association request 440 to H-AM-PCF 202. AM policy association request 440 may include the UE identifier of UE device 110. In one implementation, V-AM-PCF 204 may provide AM policy association request 440 to H-AM-PCF 202 via a modified N24 interface that is configured to support AM policy association request 440. In other implementations, AM policy association request 440 may be provided using a set of APIs configured for the AM policy service. H-AM-PCF 202 may receive AM policy association request 440 may submit a request 445 to retrieve AM policy data from other devices (e.g., UDM/UDR 220) in home network 120 and receive the AM policy data 450.

Referring to FIG. 4B, H-AM-PCF 202 may dynamically derive 455 an AM policy for UE device 110 based on AM policy data 450. For example, based on AM policy data 450, H-AM-PCF 202 may define an access and/or mobility policy for UE device 110. H-AM-PCF 202 may determine a policy for UE device 110 based on the type of subscriber and/or type of service plan associated with UE device 110. In one implementation, H-AM-PCF 202 may determine the network slice(s) that the subscriber is allowed to use in visited network 130. In another implementation, H-AM-PCF 202 may determine the UE-Aggregate Maximum Bit Rate (AMBR) that the subscriber is allowed to use in visited network 130. In other implementations, H-AM-PCF 202 may identify a particular service level or restricted roaming area for UE device 110.

H-AM-PCF 202 may send the derived policy for UE device 110 to V-AM-PCF 204 as AM policy association response 460 (e.g., via the modified N24 interface or another interface). V-AM-PCF 204 may receive AM policy association response 460 and determine a specific AM policy to support AM policy association response 460 in visited network 130. For example, V-AM-PCF 204 may indicate regional restrictions, network slice identifier, service levels, or other data to govern network services for UE device 110. V-AM-PCF 204 may provide the specific policies to AMF 206 via AM policy association response 465.

AMF 206 may receive AM policy association response 465 and may store or cache the AM policy data from AM policy association response 465. AMF 206 may send a registration accept reply 470 to access station 134 with the AM policy data. Access station 134 may relay the accept reply to UE device 110 as registration accept reply 475. Reply 475 may include policy instructions for UE device 110 while roaming on visited network 130.

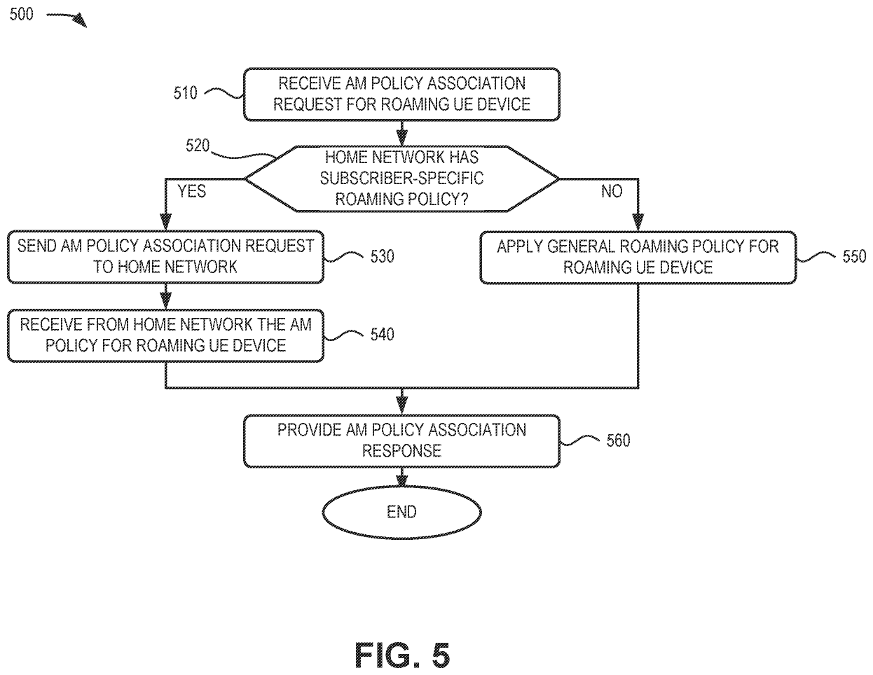

FIG. 5 is a process flow 500 illustrating exemplary operations for the AM policy service. In one implementation, the operations of process flow 500 may be performed by V-AM-PCF 204. In another implementation, some or all of the operations of process flow 500 may be performed by V-AM-PCF 204 in conjunction with one or more of network devices of network environment 100.

Process 500 may include receiving an AM policy association request for a roaming UE device (block 510). For example, UE device 110 may submit to a visited network 130 a registration request. The registration request may include, for example, a unique device and a unique ID (e.g., a PLMN ID) of a home network (e.g., home network 120). An AMF (e.g., AMF 206) may receive the registration request, perform authentication associated with registering UE 110, and provide an AM policy association request (e.g., AM policy association request 430) to a V-AM-PCF (e.g., V-AM-PCF 204).

Process 500 may further include determining if a PLMN ID for the UE device has a subscriber-specific roaming policy (block 520). For example, in response to the AM policy association request, V-AM-PCF 204 may determine a policy association approach (e.g., whether interaction with H-AM-PCF 202 is needed) based on a subscriber's home network identifier. For example, V-AM-PCF 204 may apply table 300 to either determine that a general policy is applicable for UE device 110 (e.g., based on a single roaming profile for the PLMN ID), or V-AM-PCF 204 may initiate a request to H-AM-PCF 202 (e.g., if the PLMN ID is associated with subscriber-specific roaming policies).

If the PLMN ID for the UE device has a subscriber-specific roaming policy (block 520—Yes), process 500 may include sending an AM policy association request to a home network (block 530) and receiving from the home network the AM policy for the roaming UE device (block 540). For example, assuming V-AM-PCF 204 determines that the PLMN ID of AM policy association request 430 is configured for subscriber-specific roaming, V-AM-PCF 204 may provide an AM policy association request to the home network 120 (e.g., H-AM-PCF 202). H-AM-PCF 202 may dynamically derive an AM Policy for UE device 110 based on, for example, a subscription type or price plan indicated in a subscriber profile.). H-AM-PCF 202 may send the derived policy for UE device 110 to V-AM-PCF 204 as an AM policy association response.

If the PLMN ID for the UE device does not have a subscriber-specific roaming policy (block 520-No), process 500 may include applying a general roaming policy for the roaming UE device (block 550). For example, V-AM-PCF 204 may retrieve a locally stored (e.g., within visited network 130) access and mobility policy consistent with a roaming agreement for all UE devices associated with the PLMN ID.

Process 500 may further include providing an AM policy association response (block 560). For example, determine a specific AM policy to support in visited network 130 the AM policy association response. V-AM-PCF 204 may provide the specific policies to AMF 206 via AM policy association response.

FIG. 6 is a diagram illustrating exemplary components of a device 600 that may correspond to one or more of the devices described herein. For example, device 600 may correspond to components included in UE devices 110, home network 120, visited network 130, and/or other elements illustrated in FIGS. 1 and 2. As illustrated in FIG. 6, according to an exemplary embodiment, device 600 includes a bus 605, one or more processors 610, memory/storage 615 that stores software 620, a communication interface 625, an input 630, and an output 635. According to other embodiments, device 600 may include fewer components, additional components, different components, and/or a different arrangement of components than those illustrated in FIG. 6 and described herein.

Bus 605 includes a path that permits communication among the components of device 600. For example, bus 605 may include a system bus, an address bus, a data bus, and/or a control bus. Bus 605 may also include bus drivers, bus arbiters, bus interfaces, and/or clocks.

Processor 610 includes one or multiple processors, microprocessors, data processors, co-processors, application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, and/or some other type of component that interprets and/or executes instructions and/or data. Processor 610 may be implemented as hardware (e.g., a microprocessor, etc.), a combination of hardware and software (e.g., a SoC, an ASIC, etc.), may include one or multiple memories (e.g., cache, etc.), etc. Processor 610 may be a dedicated component or a non-dedicated component (e.g., a shared resource).

Processor 610 may control the overall operation or a portion of operation(s) performed by device 600. Processor 610 may perform one or multiple operations based on an operating system and/or various applications or computer programs (e.g., software 620). Processor 610 may access instructions from memory/storage 615, from other components of device 600, and/or from a source external to device 600 (e.g., a network, another device, etc.). Processor 610 may perform an operation and/or a process based on various techniques including, for example, multithreading, parallel processing, pipelining, interleaving, etc.

Memory/storage 615 includes one or multiple memories and/or one or multiple other types of storage mediums. For example, memory/storage 615 may include one or multiple types of memories, such as, random access memory (RAM), dynamic random-access memory (DRAM), cache, read only memory (ROM), a programmable read only memory (PROM), a static random-access memory (SRAM), a single in-line memory module (SIMM), a dual in-line memory module (DIMM), a flash memory (e.g., a NAND flash, a NOR flash, etc.), and/or some other type of memory. Memory/storage 615 may include a hard disk (e.g., a magnetic disk, an optical disk, a magneto-optic disk, a solid-state disk, etc.), a Micro-Electromechanical System (MEMS)-based storage medium, and/or a nanotechnology-based storage medium.

Memory/storage 615 may store data, software, and/or instructions related to the operation of device 600.

Software 620 includes an application or a program that provides a function and/or a process. Software 620 may include an operating system. Software 620 is also intended to include firmware, middleware, microcode, hardware description language (HDL), and/or other forms of instruction.

Communication interface 625 permits device 600 to communicate with other devices, networks, systems, devices, and/or the like. Communication interface 625 includes one or multiple wireless interfaces and/or wired interfaces. For example, communication interface 625 may include one or multiple transmitters and receivers, or transceivers (e.g., radio frequency transceivers). Communication interface 625 may include one or more antennas. For example, communication interface 625 may include an array of antennas. Communication interface 625 may operate according to a protocol stack and a communication standard. Communication interface 625 may include various processing logic or circuitry (e.g., multiplexing/de-multiplexing, filtering, amplifying, converting, error correction, etc.).

Input 630 permits an input into device 600. For example, input 630 may include a keyboard, a mouse, a display, a button, a switch, an input port, speech recognition logic, a biometric mechanism, a microphone, a visual and/or audio capturing device (e.g., a camera, etc.), and/or some other type of visual, auditory, tactile, etc., input component. Output 635 permits an output from device 600. For example, output 635 may include a speaker, a display, a light, an output port, and/or some other type of visual, auditory, tactile, etc., output component. According to some embodiments, input 630 and/or output 635 may be a device that is attachable to and removable from device 600.

Device 600 may perform a process and/or a function, as described herein, in response to processor 610 executing software 620 stored by memory/storage 615. By way of example, instructions may be read into memory/storage 615 from another memory/storage 615 (not shown) or read from another device (not shown) via communication interface 625. The instructions stored by memory/storage 615 cause processor 610 to perform a process described herein. Alternatively, for example, according to other implementations, device 600 performs a process described herein based on the execution of hardware (processor 610, etc.).

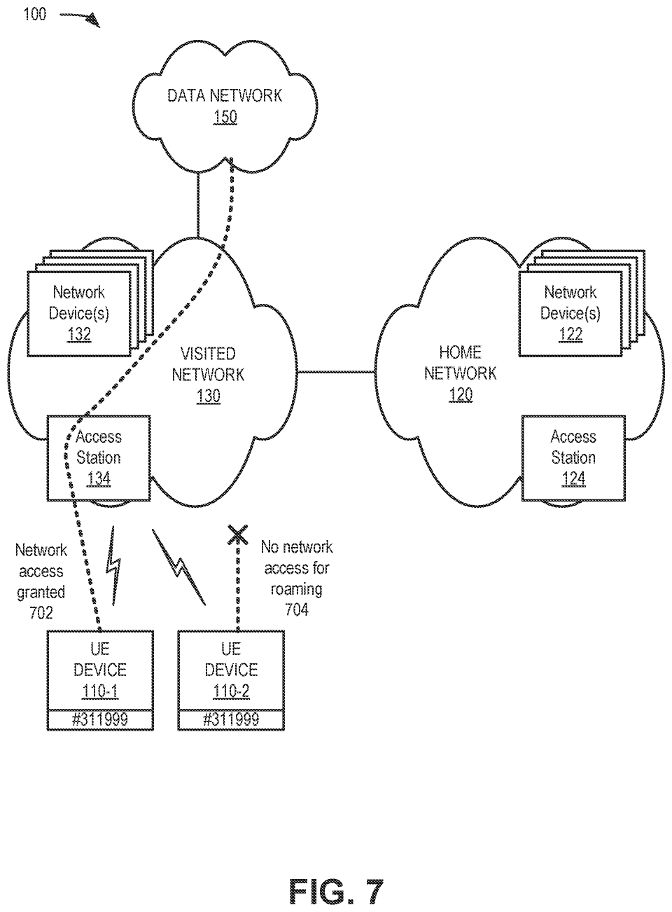

FIG. 7 illustrates a use case of the AM policy system in network environment 100, according to an implementation. More particularly, FIG. 7 illustrates a use case where UE devices with the same home network may be provided different roaming access permission in visited network 130. Assume in the example of FIG. 7 UE device 110-1 and UE device 110-2 are part of different enterprises that are both supported by home network 120 (with PLMN ID 311999). UE device 110-1 is part of an enterprise with a contractual arrangement that supports roaming within visited network 130, and UE device 110-2 is part of an enterprise with a contractual arrangement that does not include a roaming option. When UE device 110-1 and 110-2 provide the home PLMN ID to visited network 130, the visited network (e.g., V-AM-PCF 204) may use table 300 to determine that the home network for UE device 110 supports subscriber-specific roaming policies. Accordingly, visited network 130 may request a roaming access policy from home network 120 to determine (based on policy instructions from H-AM-PCF 202) that access by UE device 110-1 is allowed. Visited network 130 may also request a roaming access policy from home network 120 and determine (based on policy instructions from H-AM-PCF 202) that access by UE device 110-2 is not allowed. Thus, network access to visited network 130 may be granted 702 for UE device 110-1 and rejected 704 for UE device 110-2.

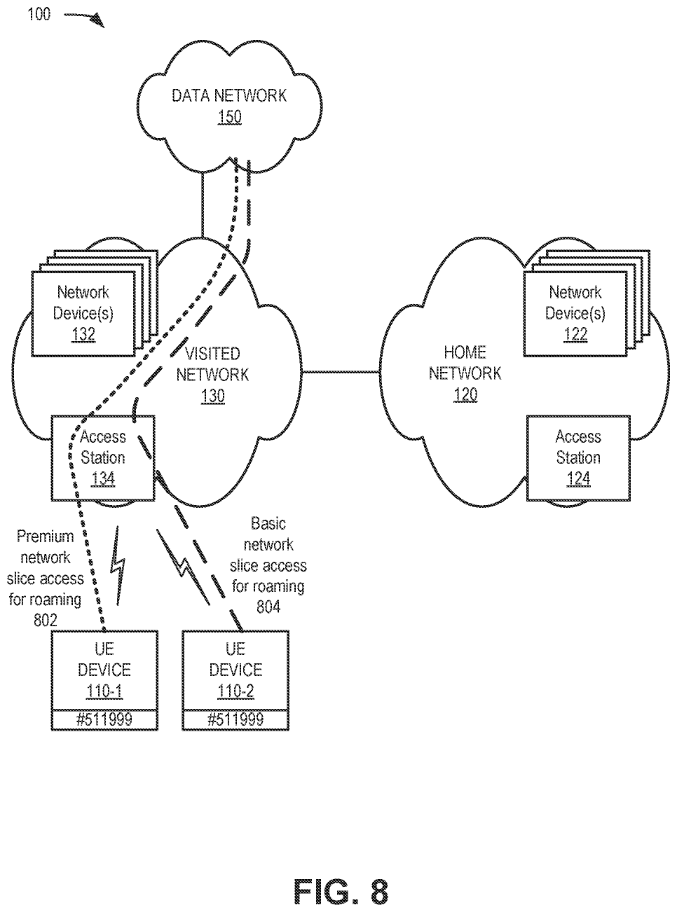

FIG. 8 illustrates another use case of the AM policy system in network environment 100, according to another implementation. More particularly, FIG. 8 illustrates a use case where UE devices with the same home network 120 may be provided different service levels in visited network 130. Assume in the example of FIG. 8 that UE device 110-1 and UE device 110-2 have subscriptions for different service plans (e.g., premium and standard) with home network 120 (with PLMN ID 511999). Assume UE device 110-1 has a premium service plan that supports enhanced QoS while roaming on visited network 130, and UE device 110-2 has a standard service plan that includes basic roaming service. When UE device 110-1 and 110-2 provide the home PLMN ID to visited network 130, the network (e.g., V-AM-PCF 204) may use table 300 to determine that the home network for UE device 110-1 supports subscriber-specific roaming policies. Accordingly, visited network 130 may request a roaming access policy from home network 120 to determine (based on policy instructions from H-AM-PCF 202) that UE device 110-1 should be assigned to a premium network slice 802 within visited network 130. Visited network 130 may also request a roaming access policy from home network 120 and determine (based on policy instructions from H-AM-PCF 202) that UE device 110-2 should be assigned to a default network slice 804 within visited network 130. Thus, visited network 130 may provide different service levels during roaming for UE device 110-1 and UE device 110-2.

As described herein, a method, a device, and a non-transitory storage medium provide an enhanced access and mobility policy service for out of bound roaming. In one implementation, a network device in a visited network may receive a roaming request for a user equipment (UE) device to connect to the visited network. The network device may determine, based on a first AM policy association request, whether a home network for the UE device has a subscriber-specific roaming policy. When the home network for the UE device has a subscriber-specific roaming policy the network device may send a second AM policy association request to the home network; receive, from the home network, the AM policy for the roaming UE device; and send an AM policy association response to the first AM policy association request.

The foregoing description of embodiments provides illustrations but is not intended to be exhaustive or to limit the embodiments to the precise form disclosed. In the preceding description, various embodiments have been described with reference to the accompanying drawings. However, various modifications and changes may be made thereto, and additional embodiments may be implemented, without departing from the broader scope of the invention as set forth in the claims that follow. The description and drawings are accordingly to be regarded as illustrative rather than restrictive. For example, while an AM-PCF is described herein as a discrete segment of a PCF, in other implementations, the AM-PCF may be included within a combined PCF structure that includes SM-PCF and UE-PCF functionality.

In addition, while series of blocks have been described with regard to the processes illustrated in FIG. 5, and series of signals with respect to FIGS. 4A-4B, the order of the blocks and/or signals may be modified according to other embodiments. Further, non-dependent blocks may be performed in parallel. Additionally, other processes described in this description may be modified and/or non-dependent operations may be performed in parallel.

The embodiments described herein may be implemented in many different forms of software executed by hardware. For example, a process or a function may be implemented as “logic” or as a “component.” The logic or the component may include, for example, hardware (e.g., processor 610, etc.), or a combination of hardware and software. The embodiments have been described without reference to the specific software code since the software code can be designed to implement the embodiments based on the description herein and commercially available software design environments/languages.

As set forth in this description and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory storage medium that stores data and/or information, such as instructions, program code, data structures, program modules, an application, etc. The program code, instructions, application, etc., is readable and executable by a processor (e.g., processor 610) of a computational device. A non-transitory storage medium includes one or more of the storage mediums described in relation to memory 615.

To the extent the aforementioned embodiments collect, store or employ personal information provided by individuals, or any other user data or subscription data, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

What is claimed is:

1. A method, comprising:
receiving, by a network device in a visited network, a roaming request for a user equipment (UE) device to connect to the visited network;
determining, by the network device and based on a first access and mobility (AM) policy association request, whether a home network for the UE device has a subscriber-specific roaming policy; and
when the home network for the UE device has a subscriber-specific roaming policy:
sending a second AM policy association request to the home network;
receiving from the home network the AM policy for the roaming UE device; and
sending an AM policy association response to the first AM policy association request.

2. The method of claim 1, further comprising:
applying a general roaming policy for the roaming UE device, when the home network for the UE device does not have a subscriber-specific roaming policy.

3. The method of claim 1, wherein the network device includes an AM-policy control function (PCF).

4. The method of claim 1, wherein sending the second AM policy association request includes:
sending the second AM policy association request to an AM-PCF in the home network.

5. The method of claim 1, wherein sending the second AM policy association request includes:
sending the second AM policy association request via a modified N24 interface.

6. The method of claim 1, wherein determining whether the home network for the UE device has a subscriber-specific roaming policy includes:
storing, in a memory of the network device, multiple Public Land Mobile Network (PLMN) identifiers (IDs) associated with a policy association approach, and
matching a home PLMN ID of the UE device with one of the PLMN IDs.

7. The method of claim 1, wherein the AM policy for the roaming UE device differentiates between one or more service levels that the UE device may access.

8. The method of claim 1, wherein sending a second AM policy association request to the home network includes:
sending a unique identifier of the UE device.

9. The method of claim 1, wherein sending the AM policy association response includes:
sending the AM policy association response to an access and mobility management function (AMF) in the visited network.

10. One or more network devices, comprising:
one or more processors configured execute instructions to:
receive, in a visited network, a roaming request for a user equipment (UE) device to connect to the visited network;
determine, based on based on a first access and mobility (AM) policy association request, whether a home network for the UE device has a subscriber-specific roaming policy; and
when the home network for the UE device has a subscriber-specific roaming policy:
send a second AM policy association request to the home network;
receive, from the home network, the AM policy for the roaming UE device; and
send an AM policy association response to the first AM policy association request.

11. The one or more network devices of claim 10, wherein the one or more processors is further to execute instructions to:
apply a general roaming policy for the roaming UE device, when the home network for the UE device does not have a subscriber-specific roaming policy.

12. The one or more network devices of claim 10, wherein the one or more network devices includes an AM-policy control function (PCF).

13. The one or more network devices of claim 10, wherein, when sending the second AM policy association request, the one or more processors is further to execute instructions to:
send the second AM policy association request to an AM-PCF in the home network.

14. The one or more network devices of claim 10, wherein, sending the second AM policy association request, the one or more processors is further to execute instructions to:
sending the second AM policy association request via a modified N24 interface.

15. The one or more network devices of claim 10, wherein, determining whether the home network for the UE device has a subscriber-specific roaming policy, the one or more processors is further to execute instructions to:
store, in a memory, multiple Public Land Mobile Network (PLMN) identifiers (IDs) associated with a policy association approach, and
match a home PLMN ID of the UE device with one of the PLMN IDs.

16. The one or more network devices of claim 10, wherein, when sending the AM policy association response, the one or more processors is further to execute instructions to:
sending the AM policy association response to an access and mobility management function (AMF) in the visited network.

17. A non-transitory computer-readable medium containing instructions executable by at least one processor of a device, the non-transitory computer-readable medium comprising one or more instructions for:
receiving, in a visited network, a roaming request for a user equipment (UE) device to connect to the visited network;
determining, based on a first access and mobility (AM) policy association request, whether a home network for the UE device has a subscriber-specific roaming policy; and
when the home network for the UE device has a subscriber-specific roaming policy:
sending a second AM policy association request to the home network;
receiving from the home network the AM policy for the roaming UE device; and
sending an AM policy association response to the first AM policy association request.

18. The non-transitory computer-readable medium of claim 17, further comprising one or more instructions for:
applying a general roaming policy for the roaming UE device, when the home network for the UE device does not have a subscriber-specific roaming policy.

19. The non-transitory computer-readable medium of claim 17, wherein the one or more instructions for determining whether the home network for the UE device has a subscriber-specific roaming policy include:
storing, in a memory, multiple Public Land Mobile Network (PLMN) identifiers (IDs) associated with a policy association approach, and
matching a home PLMN ID of the UE device with one of the PLMN IDs.

20. The non-transitory computer-readable medium of claim 17, wherein the one or more instructions for sending the second AM policy association request include:
sending the second AM policy association request to an AM-PCF in the home network.
